(19) United States
(12) Patent Application Publication
(10) Pub. No.: US 2017/0339967 A1
(43) Pub. Date: Nov. 30, 2017

(54) CONVEYING DEVICE HAVING PORTION TRANSFER

(71) Applicant: WEBER MASCHINENBAU GMBH BREIDENBACH, Breidenbach (DE)

(72) Inventors: Alexander Burk, Dautphetal (DE); Christoph Eckhardt, Breidenbach (DE); Jochen Gerlach, Dautphetal (DE); Marco Nichau, Bad Laasphe (DE); Thomas Nispel, Dautphetal (DE); Ingo Rother, Breidenbach (DE); Leopold Von Keudell, Salem (DE); Steffen Zecher, Staufenberg (DE)

(21) Appl. No.: 15/534,469

(22) PCT Filed: Dec. 14, 2015
(86) PCT No.: PCT/EP2015/079630

§ 371 Date: Jun. 8, 2017

(30) Foreign Application Priority Data
Dec. 18, 2014 (DE) 10 2014 118 978.7

(51) Int. Cl. A22C 17/00; B65B 25/06; B26D 7/32; B65B 35/36; B65B 35/44; B65B 57/14; B65B 5/12

(52) U.S. Cl. CPC A22C 17/0073; B26D 7/32; A22C 17/0093; B65B 25/06; B65B 5/12; B65B 35/44; B65B 57/14; B65B 2210/02; B65B 35/36

(57) ABSTRACT

The invention relates to a system having a conveying apparatus for moving portions that each comprise at least one slice cut off from a food product, in particular by means of a slicing apparatus, in particular by means of a high-speed slicer; having at least one packaging apparatus for packaging the portions; and having at least one transfer device for transferring the portions from the conveying apparatus to the packaging apparatus, wherein the conveying apparatus comprises a plurality of individually movable transport movers for the transport of portions, a path system for the transport movers in which the transport movers are movable along at least one predefined path in a transport direction, and a control device for controlling the movements of the transport movers in the path system, wherein the transport movers each comprise at least one rotor cooperating with the path system and at least one carrier for portions attached to the rotor; and wherein the transfer device is configured to form a single-line or multi-line format set from a plurality of portions of different transport movers and to transfer the format set as a whole to the packaging apparatus.

The invention relates to a system having a conveying apparatus for moving portions that respectively comprise at least one slice cut off from a food product, in particular from sausage, cheese, ham, meat or the like. The slices can in particular be cut off by means of a slicing apparatus, preferably by means of a high-speed slicer. The apparatus comprises a plurality of individually movable transport movers for the transport of portions, a path system for the transport movers in which the transport movers are movable along at least one predefined path in a transport direction, and a control device for controlling the movement of the transport movers in the path system. The transport movers each comprise at least one rotor cooperating with the path system and at least one carrier for portions attached to the rotor. The carrier can be configured as a tray of a packaging or can comprises a tray of a packaging. Alternatively, the carrier can also take up a tray or can take up portions directly i.e. without a tray. The drive for the transport movers can, for example, be formed as a linear motor, in particular as a linear synchronous motor or as a linear induction motor.

Such linear motors are generally known in connection with a plurality of applications. Such a drive principle is inter alia advantageous when comparatively small loads are to be transported such as is the case in the sector of the transport of food products in question here.

A transport system which can generally be used for the invention and to which reference is herewith explicitly made with respect to the requirement of performability of the invention is offered by the company MagneMotion, Inc., domiciled in Devens, Mass., USA. This system is based on a so-called LSM drive, that is on a drive by linear synchronous motors which is to be distinguished from a so-called linear induction motor (LIM drive). Unlike an LIM drive, in an LSM drive, a magnetic field is not induced by means of the so-called electromagnetic traveling field, but the magnetic field is provided by permanent magnets. When the rotor of the linear motor carries the permanent magnets and the stator of the linear motor generates the electromagnetic traveling field, the drive principle of an LSM drive can be figuratively imagined such that the transport mover provided with the permanent magnets is pulled over the transport line by the magnetic field moving along the stator. Such a transport system or drive principle is described, for example, in WO 2003/029651 A2 and WO 2010/085670 A1. Reference is herewith explicitly made to these documents with reference to the disclosure of a possible drive principle or function principle for the invention.

The path system or the individual paths of such a transport system can be divided into a plurality of consecutive path elements which so-to-say each form a single linear motor and can be individually controlled by a control device. If the transport movers located in the path system can be identified simultaneously by means of the control device, generally any desired number of transport movers can then be operated simultaneously in a path system of generally any desired complexity and can be individually moved in this respect.

The above-mentioned company MagneMotion, Inc. uses a technique for the identification and localization of the individual transport movers in the path system in which each transporter mover is provided with a transducer which induces a signal in the stator formed by the path system, whereby it makes it possible for the control device to determine the exact position of the transport mover with an accuracy dependent on the size of the total system of fractions of a millimeter or fractions of a centimeter. An advantage of this system comprises no external sensors being required. In the control system of the company MagneMotion, Inc., it is additionally ensured by a division of the paths into a plurality of path elements—which so-to-say each represent a single linear motor—that no collisions occur between the transporter movers following one another. A transport mover can thus then only travel into the next path element when it is allowed by the control device, which is in particular not the case when another transport mover is in the path element.

Against the background of this generally known transport system, provision is made in a possible embodiment in the invention that the path system is configured as a stator of the linear motor.

The rotor is in particular a respective component of a linear synchronous motor, with the rotor in particular comprising at least one permanent magnet and with the path system being configured as a motor stator.

The path system is preferably divided into a plurality of path elements which in particular each represent a single linear motor and which are individually controllable by the control device.

The transport movers are preferably identifiable by the control device.

The transport movers can furthermore be localized in the path system by the control device.

The transport system has a plurality of transport movers whose total number depends on the respective application. Provision can be made that the path system comprises several dozen up to some hundred transport movers, i.e. a positive “cluster” of transport movers can be present in the path system to transport a plurality of portions and optionally to carry out additional functions such as a buffering, a distribution and/or an association of portions.

It would generally be conceivable to pick up portions for packaging individually from transport movers by a robot using a gripper that is also called a picker and to place them individually into a packaging apparatus. The packaging would thus be comparatively slow. It could therefore happen that substantially more portions are sliced by the slicing apparatus and are transported by the transport movers than can be placed into the packaging apparatus in the same time by an individual robot. If, in contrast, a plurality of portions should be packaged at the same time, it would be necessary that a plurality of robots are present. This would, however, be associated with relatively high costs.

Due to a packaging procedure that is too slow in view of this background, the maximum performance of the path system would possibly not be fully exploited.

It is therefore an object of the invention to provide a system having a conveying apparatus for moving portions as well as a corresponding method that enable portions to be packaged as efficiently as possible.

This object is satisfied by an apparatus and by a method each having the features of the independent claims.

In accordance with the invention, the system comprises a transfer device for transferring the portions from the conveying apparatus to the packaging apparatus.

The term “portion” is to be understood as broad within the framework of the invention. A portion can accordingly consist of only one single slice. Alternatively, a portion can comprise a plurality of slices which can be present in a relative arrangement of generally any form, for example in a so-called stacked or overlapping arrangement such as is familiar to the skilled person in the technical field in question here. The portion can be a total portion such as is subsequently packaged and offered for sale on the market. Alternatively, the portion can be a part portion which only forms a total portion together with one or more further part portions which can in turn each comprise one or more slices. The part portions of a total portion can be formed from different product sorts so that a multi-sort portion can be produced by assembling a plurality of part portions and so that a multi-sort pack is thus present after their packaging. The slices can, for example, be comparatively thin slices such as are generally known in the form of assorted slices of sausage or of cheese. Alternatively, the slices can each be pieces that are relatively thick in comparison with assorted slices such as pieces of fresh meat.

In other words, a portion within the framework of the invention is the unit which is the smallest with respect to the transport task, which has to be transported over a specific line, on the one hand, and which optionally—depending on the application—additionally has to be put into relation with further portions, on the other hand, to satisfy the respective demands of the total system which comprises one or more slicing apparatus, in particular slicers, the path system, and one or more packaging apparatus. They are, for example, demands with respect to the formation of formats such as have to be provided for the respectively provided packaging apparatus.

A transport mover can transport one or more portions. It is alternatively also possible that a plurality of transport movers, in particular two transport movers, transport a portion together. The transport movers can in this respect so-to-say be moved together as a unit on the path system. In this manner, larger loads, in particular heavier portions and/or portions larger in area, can also be moved on the path system than with only one transport mover.

The transfer device is configured to form a single-line or multi-line format set from a plurality of portions of different transport movers and to transfer the format set as a whole to the packaging apparatus. A plurality of portions are thus simultaneously transferred to the packaging apparatus. The portions are in particular transferred to the packaging apparatus and are placed into trays, for example. The speed during packaging can thereby be considerably increased. The total system can in particular be run at a high performance without influences arising on the conveying apparatus due to the packaging procedure.

A format set is formed before the portions are transferred to the packaging apparatus. The format set comprises at least one line of a plurality of portions arranged next to one another. The format set is preferably formed in multiple lines, i.e. so-to-say in the form of a matrix of portions. The portions are preferably aligned at a grid. The conveying system can in particular also contribute at least in part to the format set formation by a steering of the transport movers to a specific position of the path. The portions can thus be moved to a specific transfer position from which they are transferred to the transfer device. The transfer device can in particular be configured to move portions and to format portions. An alignment, grouping, rotating or the like is also covered by a formatting within the framework of the present disclosure.

The portions can also already be located in trays that are in particular moved on the path system. The trays can be transferred to the transfer device from the transport movers. The trays can subsequently be aligned and transferred to a packaging apparatus in which they are closed, for example. The term “portion” thus also includes a portion that is arranged in a tray.

The transfer device can in particular also comprise at least one robot having a gripper, e.g. a so-called picker, as well as a conveyor belt. The robot can in this respect pick up portions individually from the transport movers and place them onto a common conveyor belt. Once a format has been prepared on the conveyor belt, it can thus be transferred to the packaging apparatus as a whole. A plurality of portions are thus always packaged simultaneously in this variant.

Further developments of the invention can also be seen from the dependent claims, the description and the enclosed drawings.

In accordance with an embodiment, the transfer device comprises a formatter that picks up the portions directly from the transport movers. The portions are in particular already formatted on the picking up by the transfer device. In particular no robot having a gripper is used for the formatting.

In accordance with a further embodiment, the format set is formable on the formatter. The formatter, for example, comprises a planar surface on which a plurality of portions can also be arranged next to one another. The portions in particular move directly from the transport movers onto the formatters. A robot or the like is not necessarily provided in this respect.

The formatter can in particular align the portions and prepare one or more tracks or lines of the format set. The track spacings and/or line spacings of the portions with respect to one another in a format set can in particular be fixed by the formatter.

In accordance with a further embodiment, the formatter comprises a single-part conveyor belt, a conveyor belt divided into a plurality of individually movable tracks or a plurality of separate individual conveyor belts. A single-part conveyor belt or the conveyor belt divided into tracks can in particular be at least as wide as a line of the format set. The separate individual conveyor belts are preferably oriented in parallel with one another. Alternatively to conveyor belts, the formatter can also use other suitable conveyors. Conveyor belts have the advantage, however, that they can in particular be manufactured inexpensively.

In accordance with a further embodiment, the transfer device comprises a support for the format set. The support is in particular at least as wide as a line of the format set. The support can preferably be identical to the formatter, at least in some embodiments. In other embodiments, the support can, however, also be a component additional to the formatter. The support is in particular long enough to also be able to pick up a plurality of lines or rows of portions after one another. A matrix or a grid of portions can arise in this manner. A complete format set thus in particular lies on the support before it is transferred as a whole to the packaging apparatus.

In accordance with a further embodiment, the support comprises a single-part conveyor belt or a conveyor belt divided into a plurality of individually movable tracks. Even if conveyor belts can be at least advantageous under certain conditions, it is not compulsory that the support comprises a conveyor belt. Other suitable conveyors are thus also generally conceivable.

In accordance with a further embodiment, the transfer device comprises a dispensing apparatus by means of which the support can moved, in particular pivoted, as a whole to a dispensing region in which the format set can be dispensed to the packaging apparatus. The dispensing apparatus can in particular comprise a pivotable robot arm, a rotating plate and/or corresponding conveyor belts that move the support. The robot arm can in this respect be configured comparatively simply and can only carry out a simple movement. Complex robots having grippers that carry out complicated movement procedures and have a corresponding sensor system are in particular not necessary, but can generally likewise be used. The movement can preferably comprise a pivoting by 90°. The angle can, however, generally be any one desired and can preferably be selected in dependence on an angle on the picking up of the portion. The orientation of the portion, i.e. lengthways or transversely, can in particular be fixed in this step, and indeed depending on the demand of the respective packaging apparatus. A pivoting by 90° namely provides a reorientation of a portion, for example from a lengthways orientation into a transverse orientation, and vice versa. The dispensing apparatus can in this respect be selected or set accordingly as desired.

In accordance with a further embodiment, at least one or each transport mover is movable to a predefinable position of a pick-up region at which the transfer device picks up the portion. From the point of view of the path system, this region can also be called a dispensing region, preferably in the case that the transport mover can itself actively dispense, e.g. with the aid of a belt or of a tilting apparatus. In particular when a plurality of transport movers are provided, the relative spacing of the transport movers from one another can also be fixed with reference to the positions. The position at which the transport movers are stopped can thus be fixed. The position can in particular be variable. The position or variability of the position can relate both to the path and to an individually predefinable transfer point and to an associated transfer device. It is furthermore possible to vary the position with respect to at least one further transport mover and/or one further portion, in particular an associated portion, as a part portion. The transport movers can also be stopped after one another at different positions in order thus to successively fill a line of the format set.

In accordance with a further embodiment, the position is adaptable to the location of the portion on the transport mover or is variable in dependence on the location of the portion on the transport mover. The location of the portion in particular relates either to an individual transport mover or to at least one further transport mover whose portion forms an associated part portion or an associated portion in a format set, in particular a common format set. The stopping places of the transport movers therefore do not have to be governed by the transport movers themselves, for example with a center of the transport movers, but can be governed by the location of the portion that is located on the transport mover.

Since portions—and not the transport movers themselves—are transferred to the transfer device, the portions are thus already arranged at the correct position of a later format set, i.e. of the format set to be formed.

A positioning or an adapting of the position of a transport mover with reference to the location of the portion on this transport mover is also possible independently of the formation of a format set, i.e. a plurality of portions can be positioned in a desired manner relative to one another in that the transport movers of these positions are correspondingly positioned relative to one another. Protection is hereby also independently claimed for this aspect, i.e. independently of a formation of a format set. This can be advantageous, for example, with continuously working apparatus or packaging apparatus such as so-called tray sealers, tubular bag machines and/or flow pack machines for which no format sets have to be prepared. In this category of apparatus or packaging apparatus, the required spacings of the portions from one another are ensured via the path system in accordance with the invention and via the control or positioning of the transport movers such that, for example, the previously used single-ended apparatus, that in particular comprise a plurality of conveyor belts, are no longer required.

In accordance with a further embodiment, a detection device, in particular an optical device, is provided, preferably having at least one camera, that determines the location of the portion on the transport mover. The position data determined by the detection device can subsequently be forwarded to the control device that stops the transport movers at the calculated position.

In accordance with a further embodiment, the position is adaptable or variable such that the portion is arranged on the transport movers in accordance with the format set to be formed and/or in accordance with a transfer position corresponding to the transfer device. The transfer position in this respect corresponds to the position of the transport movers on the transfer of portions to the transfer device. The positions are thus in particular adapted with respect to the location of the portions in the later format set. The transport movers are preferably stopped next to one another such that the respective portions located thereon have a constant spacing from one another.

In accordance with a further embodiment, the transfer device comprises an alignment apparatus that arranges the portions in accordance with the format set to be formed. In this case, the position of the transport mover does not have to depend on the location of the position or the position does not have to be absolutely exactly since the location of the portion can subsequently still be corrected. The correction can preferably take place in at least one direction. The correction can in particular also already take place at the moment of the pick-up onto the transfer device and/or on the dispensing.

In accordance with a further embodiment, the alignment apparatus comprises an alignment belt that is associated with the transport mover. In general, however, any desired suitable alignment apparatus are conceivable.

In accordance with a further embodiment, the alignment apparatus is movable, in particular pivotable and/or travelable, laterally and/or in parallel with the conveying direction. The alignment apparatus can thus move to align the portions on the way to the formatter, to the support and/or to the packaging apparatus.

In accordance with a further embodiment, the transfer device is configured to pick up a plurality of portions from the transport movers simultaneously. A plurality of portions can in particular be picked up together. In this respect, the transport movers can already be grouped on the path in accordance with the later format set and can, for example, be positioned in accordance with the location of the portions on the transport movers at a desired spacing.

In this case, a portion is thus not picked up one after the other from the transfer device, but rather a plurality of portions simultaneously. The throughput of portions during packaging can thereby be increased.

In accordance with a further embodiment, the spacings of the positions of the transport movers from one another are adaptable or variable such that the portions are spaced apart from one another by the transport movers in accordance with the format set to be formed. A portion-related spacing of the transport movers at the pick-up region in particular thus results. The spacing is preferably determined from the spacing of one portion center from the next portion center. A uniform spacing between the portions within one line, preferably within all the lines, of the format set can in particular be set. This in particular corresponds to the track spacing of the packagings.

In accordance with a further embodiment, an individual conveyor belt of the formatter, in particular configured as a conveyor belt, is associated with each transport mover. The portions of the different transport movers can in particular be picked up from the formatter independently of one another.

In accordance with a further embodiment, the individual conveyor is configured as rigid or as an alignment unit. The conveyor belt can in particular be moved, for example pivoted or displaced. All the conveyor belts can preferably be moved independently of one another. Possible incorrect positions of the portions on the transport movers can be corrected individually per track in this manner. Preferably, either all the individual conveyors are movable or all the individual conveyors are rigid.

The individual conveyors can in particular be configured overall and/or in at least one end region displaceable or pivotable transversely to the conveying direction. Bands and belt straps can preferably be crossed over the length of an individual conveyor.

In accordance with a further embodiment, the transfer device is configured to consecutively pick up portions from the transport movers. The picking up of the portions takes place offset in time while the transfer of the format set to the packaging apparatus, in contrast, takes place simultaneously for the portions forming the format set. At least a part of the format set can in particular thereby be prepared during the picking up.

In accordance with a further embodiment, the transport movers are movable after one another into the same position. The position can in particular relate to the path, to the portion location and/or to an associated transfer device or to the position on the transfer device. A position is thus traveled to consecutively by the transport movers, i.e. the picking up onto the transfer device always takes place at the same transfer point. However, a plurality of such transfer points can also be strung together, for example when portions having a first property are transferred at a first point and portions having a further property are transferred at a further point.

In accordance with a further embodiment, the transfer device as a whole, a formatter of the transfer device and/or a support of the transfer device are movable in at least one direction to pick up portions of different transport movers. The movement in particular takes place in exactly one dimension. It is possible in this manner to pick up portions that are moved after one another into the same position or are distributed at any desired positions on the path such that a format set can be prepared. The transport movers are in this respect in particular passive, i.e. the format set formation takes place at least substantially by the transfer device or components hereof. The transfer device, the formatter or the support can in particular be moved in parallel with the path to thus fill a line of the format consecutively.

In accordance with a further embodiment, a line of the format set on the transport device is formable in parallel with or at right angles to the transport direction. The transport device in this respect relates to the movement of the transport movers on the path. The portions can in particular be transferred in parallel with the track or perpendicular to the track.

The invention also relates to a method of packaging portions which each comprise at least one slice cut off from a food product, in particular by means of a slicing apparatus, in particular by means of a high-speed slicer. A conveying direction transports portions with a plurality of individually movable transport movers. A path system moves the transport movers along at least one predefined path in a transport direction and a control device controls the movement of the transport movers in the path system. A transfer device transfers portions from the conveying device to at least one packaging apparatus, with the transfer device forming a single-line or multi-line format set from a plurality of portions of different transport movers and transferring the format set as a whole to the packaging apparatus by means of which the portions are packaged.

All the embodiments of the apparatus described here are in particular configured to be operated in accordance with the method described here. Furthermore, all the embodiments of the apparatus described here as well as all the embodiments of the method described here can each be combined with one another.

The invention will be described in the following by way of example with reference to the drawings. There are shown:

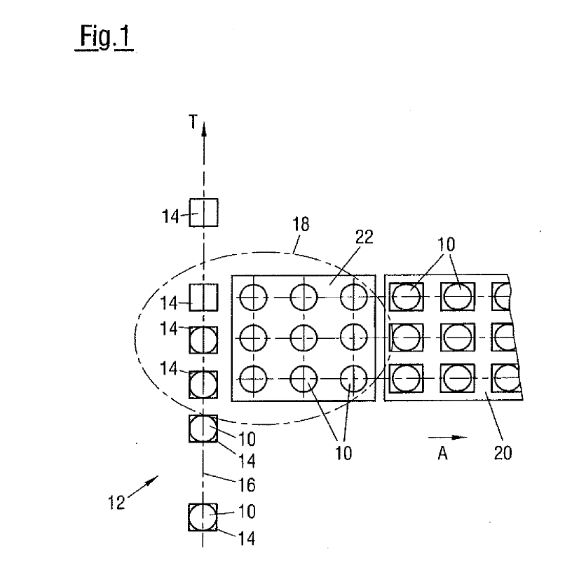

FIG. 1 to FIG. 11 schematic plan views of different embodiments of the system in accordance with the invention.

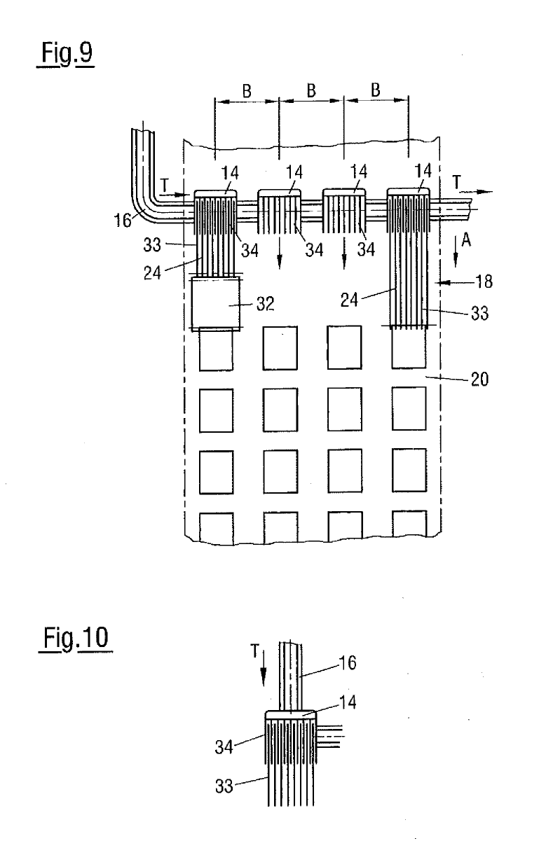

It must first be noted that the embodiments shown are of a purely exemplary nature. The number of transport movers and tracks shown can in particular vary. Different transfer mechanisms can also be provided for picking up the portions on the formatter. A rake-like gripper such as is shown in FIG. 9 to FIG. 11 can thus in particular be replaced with other suitable apparatus, e.g. conveyor belts. The features of an embodiment can also be combined as desired with features of another embodiment.

A conveying apparatus 12 for moving portions 10 is shown in FIG. 1. The conveying apparatus 12 comprises a plurality of transport movers 14 for the transport of the portions 10 that can move in a path 16 in the transport direction T.

The portions 10 can be transferred by means of a transfer device 18 whose working range is shown by way of example as a chain-dotted oval to a packaging apparatus 20.

The transfer device 18 comprises a robot, not shown, having a picker as well as a conveyor belt 22 on which a format set is formed. The picker can remove portions 10 from the transport movers 14 and can place them onto the conveyor belt 22 in a predefined format set. The fully formed format set can now be transferred as a whole to the packaging apparatus 20 with the aid of the conveyor belt 22. In this respect, the conveyor belt 22 can, for example, be configured as a blade-edge belt or as a fast-retracting transport belt. Due to inertia, the portions 10 remain at the corresponding position, while the conveyor belt 22 moves back fast thereunder. The portions 10 are placed into the packaging apparatus 20 in this manner. The fully packaged portions 10 can be transported off in the removal direction A. Portions 10 that are cut off from a slicing apparatus, in particular by a circular blade or a scythe-like blade revolving in planetary motion and/or in a rotational manner, are moved on the path 16 by the transport movers 14 and are stopped at a predefined position. One or more robots simultaneously pick portions 10 from the transport movers 14 there. The portions 10 are subsequently placed onto the conveyor belt 22 in a format set and are transferred from there as a whole to the packaging apparatus 20.

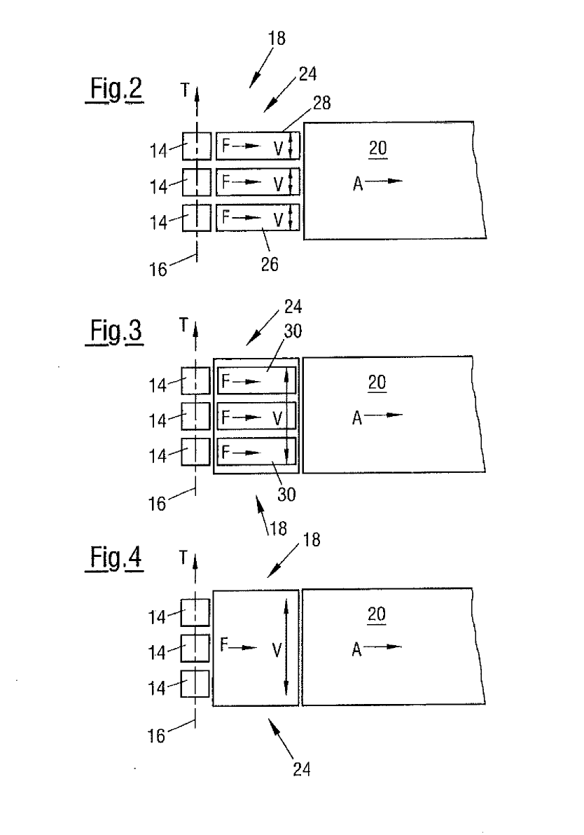

In the further embodiments, no respective robot having a picker is provided. In accordance with the embodiments shown in FIGS. 2 to 4, the transfer device 18 comprises a formatter 24.

In accordance with FIG. 2, the formatter 24 has three parallel individual conveyor belts 26. The individual conveyor belts 26 can be configured ether as rigid or as movable alignment apparatus 28 and can be adjusted at a right angle or obliquely to a conveying direction F in the adjustment direction V. Incorrect locations of the portions 10 on the transport movers 14 can thus be corrected on the way to the packaging apparatus 20. A format set can thus be formed on the formatter 24 from portions 10, said format set being transferred as a whole to the packaging apparatus 20.

In accordance with FIG. 3, the formatter 24 is configured as a conveyor belt divided into a plurality of tracks 30 movable individually. Each track 30 is in particular formed by an individual conveyor belt 26. The formatter 24 can in this respect be adjusted as a whole in the adjustment direction V to compensate any possible incorrect location of a line of portions 10.

The transport movers 14 are, however, preferably already stopped at exactly predefinable positions on the path 16, in particular at specific spacings between the portions 10 of the different transport movers 14. The positioning in this respect takes place with reference to the location of the portions 10 on the transport movers 14. The location of the portions 10 can be determined by means of a detection device.

The portions 10 are ideally already at the correct position of the later format set. An alignment apparatus 28 is therefore not absolutely necessary on an exact positioning of the transport movers 14 with reference to the portion locations, but can e.g. nevertheless be provided to be able to carry out an alignment as required.

In accordance with the embodiment shown in FIG. 4, the formatter 24 is configured as a conveyor belt. The conveyor belt 24 can either move only in the conveying direction F. Alternatively, however, a movement in the adjustment direction V is additionally conceivable. The portions 10 are in this respect picked up by a common conveyor belt 24 and can in particular already be at the correct spacing from one another due to the exact positioning of the transport movers 14.

An adjustability in the adjustment direction V of an individual conveyor belt 26 or of a common conveyor belt 24 is in particular also advantageous in a variant in which all the transfer movers 14 are traveled consecutively to the same position or are at any desired positions in the path. In this respect, the formatter 24 can be moved in one dimension in the adjustment direction V to collect the portions 10 at the correct position for the later format set. The adjustment direction V can in this respect be at a right angle to the conveying direction F.

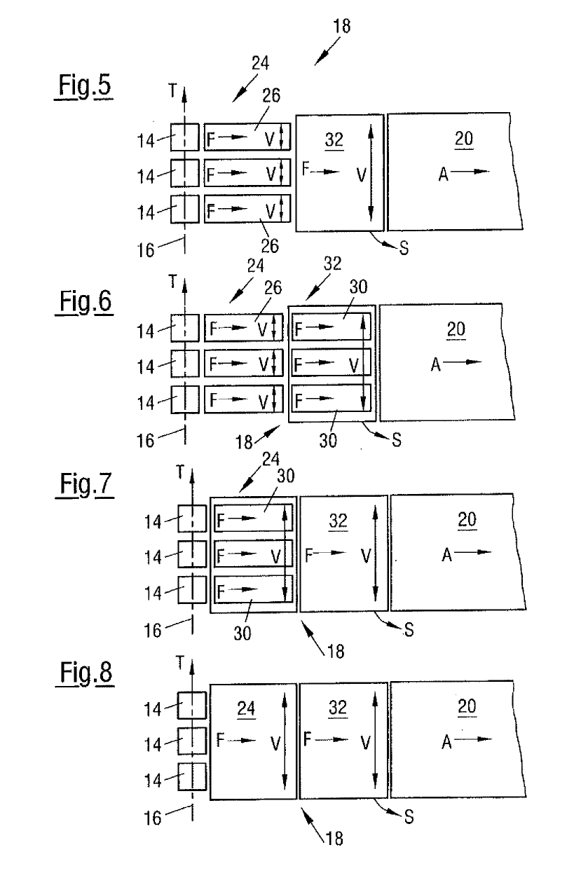

As is shown in FIGS. 5 to 8, the transfer device 18 can also comprise a support 32 in addition to the formatter 24. In the previous embodiments, the formatter 24 in contrast corresponds to the support 32 or the support 32 is formed by the formatter 24 so that the statements made here with respect to the support 32 can also apply to these variants.

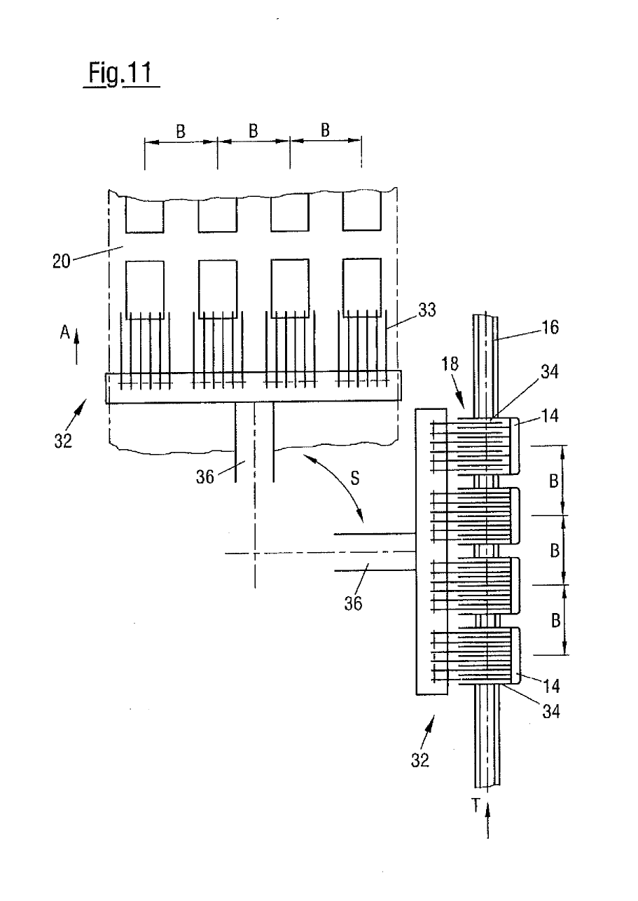

A fully formed format set in particular lies on the support 32 before it is transferred as a whole to the packaging apparatus 20. The support 32 can also be configured analog to the formatter 24 as a single-part conveyor belt or as a support 32 divided or segmented into individually movable tracks 30. Each track 30 can in turn be formed by an individual conveyor belt 26. The movability in the adjustment direction V can also be given. If a formatter 24 is connected upstream of the support 32, either the formatter 24 or the support 32 can be adjusted in the adjustment direction V. It is alternatively also possible that both the formatter 24 and the support 32 can be adjusted in the adjustment direction V. It is furthermore possible that the support 32 is pivoted in the pivoting direction S to dispense the portions 10 to the packaging apparatus 20, for example offset by 90°. This will be looked at more exactly in connection with FIG. 11.

Two different possibilities for picking up the portions 10 are shown on a formatter 24 in FIG. 9.

The portion 10 is combed over bands 33 in a first variant in the left part of FIG. 9. The transfer in this respect first takes place to the support 32. The portion 10 is finally transferred from the support 32 to the packaging apparatus 20.

An alternative is shown on the right side of FIG. 9 according to which the portions 10 are placed combed and with the aid of bands 33 that represent the formatter 24 directly into the packaging apparatus 20. The formatter 24 is identical with the support 32 in this respect.

The above-explained variants are only shown simultaneously here in FIG. 9 to avoid a separate figure. Within a respective specific embodiment, all the formatters 24 of a total transfer device preferably work in accordance with the same principle, that is either as shown at the left in FIG. 9 or as shown at the right in FIG. 9, with generally different mechanisms or principles, however, also generally being conceivable for the formatters 24 within a transfer device 18.

To be able to pick up the portions 10, the transport mover 14 has a grid-shaped carrier 34. The term “grid-shaped” is to have a broad interpretation. A rake, a plurality of parallel bars and/or a surface having apertures are thus also covered, for example. Due to the grid-shaped embodiment of the carrier 34, portions 10 located thereon can be removed with the aid of a gripper likewise comprising a grid or with the aid of bands 33. The portion location can also be corrected on the engaging beneath of the carrier 34 in that the gripper e.g. only engages up to a specific portion. The portions 10 can in particular be combed obliquely upwardly by a belt or band 33. The transport mover 14 preferably has a holder for the carrier 34 that is configured as areal and continuous beneath the grid such that contamination falling from the grid onto the holder is collected and does not fall onto the path 16.

The bands 33 can consequently engage in the grid-like carrier 34 and transport the portions 10 to the packaging apparatus 20.

The transport movers 14 can be stopped at exact positions of the track 16 for the transfer. The transport movers 14 can in particular be stopped at a specific spacing B of the portions 10 with respect to one another. The formatting of the portions 10 in this respect already takes place partly with the aid of the path system. After the formatting, the portions 10 can be transferred together to the formatter 24 or to the support 32 such that at least one single-line format set is transferred in common to the packaging apparatus 20.

The portions 10 can be dispensed at a right angle to the transport direction T. It is alternatively also possible to dispense the portions 10 as shown in FIG. 10 in parallel with the transport direction T.

An embodiment is shown in FIG. 11 in which the support 32 can be pivoted in the pivot direction S. The transport movers 14 are first positioned at exact positions with respect to the location of the portions 10. The portions 10 are subsequently removed from the carriers 34 of the transport movers 14 with the aid of the bands 33. A single-line format set is now located on the support 32. The support 32 is pivoted by 90° in the pivot direction S toward the packaging apparatus 20. The format set is subsequently simultaneously transferred to the packaging apparatus 20.

A dispensing apparatus 36 that can comprise a robot arm is provided for pivoting the support 32. The spacing B of the portions 10 from one another in the packaging apparatus 20 corresponds to the spacing B that the portions 10 already had on the path 16 before the pick-up by the transfer device 18.

In accordance with the invention, a plurality of portions 10 can be transferred to the packaging apparatus 20 simultaneously. This is also possible without the use of high-cost robots, in particular without so-called “pickers”.

### REFERENCE NUMERAL LIST

10 portion

12 conveying apparatus

14 transport mover

16 path

18 transfer device

20 packaging apparatus

22 conveyor belt

24 formatter, conveyor belt

26 individual conveyor belt

28 alignment apparatus

30 track

32 support

33 band

34 carrier

36 dispensing apparatus, robot arm

T transport direction

A removal direction

F conveying direction

V adjustment direction

S pivot direction

B spacing

1.-23. (canceled)

24. A system comprising
a conveying apparatus for moving portions that each comprise at least one slice cut off from a food product;
at least one packaging apparatus for packaging the portions; and
at least one transfer device for transferring the portions from the conveying apparatus to the packaging apparatus,
wherein the conveying apparatus comprises
a plurality of individually movable transport movers for the transport of portions;
a path system for the transport movers in which the transport movers are movable in a transport direction along at least one predefined path; and
a control device for controlling the movements of the transport movers in the path system;
wherein the transport movers each comprise at least one rotor cooperating with the path system and at least one carrier for portions attached to the rotor; and
wherein the transfer device is configured to form a single-line or multi-line format set from a plurality of portions of different transport movers and to transfer the format set as a whole to the packaging apparatus.

25. The system in accordance with claim 24,
wherein the transfer device comprises a formatter that picks up the portions directly from the transport movers.

26. The system in accordance with claim 25,
wherein the format set is formable on the formatter.

27. The system in accordance with claim 25,
wherein the formatter comprises one of a one-part conveyor belt, a conveyor belt divided into a plurality of individually movable tracks, and a plurality of separate individual conveyor belts.

28. The system in accordance with claim 24,
wherein the transfer device comprises a support for the format set.

29. The system in accordance with claim 28,
wherein the support comprises one of a one-part conveyor belt and a conveyor belt divided into a plurality of individually movable tracks.

30. The system in accordance with claim 28,
wherein the transfer device comprises a dispensing apparatus by means of which the support is movable as a whole to a dispensing region in which the format set is dispensable to the packaging apparatus.

31. The system in accordance with claim 24,
wherein at least one or each transport mover is movable to a predefinable position of a pick-up region at which the transport device picks up the portion.

32. The system in accordance with claim 31,
wherein the position is adaptable to a location of the portion on the transport mover or is variable in dependence on the location of the portion on the transport mover.

33. The system in accordance with claim 32,
wherein a detection device is provided that determines the location of the portion on the transport mover.

34. The system in accordance with claim 31,
wherein the position is adaptable or variable such that the portion on the transport mover is arranged in accordance with the format set to be formed and/or in accordance with a transfer position corresponding to the transfer device.

35. The system in accordance with claim 24,
wherein the transfer device comprises an alignment apparatus that arranges the portions in accordance with the format set to be formed.

36. The system in accordance with claim 35,
wherein the alignment apparatus comprises an alignment belt that is associated with the transport mover.

37. The system in accordance with claim 35,
wherein the alignment apparatus is movable laterally and/or in parallel with the conveying direction.

38. The system in accordance with claim 24,
wherein the transfer device is configured to pick up a plurality of portions from the transports movers simultaneously.

39. The system in accordance with claim 24,
wherein spacings between the positions of the transport movers are adaptable to one another or are variable such that the portions on the transport movers are spaced apart from one another in accordance with the format set to be formed.

40. The system in accordance with claim 24,
wherein an individual conveyor of the formatter is associated with each transport mover.

41. The system in accordance with claim 40,
wherein the individual conveyor is configured as rigid or as an alignment apparatus.

42. The system in accordance with claim 24,
wherein the transfer device is configured to pick up portions consecutively from the transport movers.

43. The system in accordance with claim 42,
wherein the transport movers are movable after one another into the same position.

44. The system in accordance with claim 24,
wherein the transfer device as a whole, a formatter of the transfer device and/or a support of the transfer device are movable in at least one dimension to pick up portions of different transport movers.

45. The system in accordance with claim 24,
wherein a line of the format set on the transfer device is formable in parallel with or at a right angle to the transport direction.

46. A method of packaging portions that each comprise at least one slice cut off from a food product;
in which a conveying apparatus transports portions using a plurality of individually movable transport movers; a path system moves the transport movers along at least one predefined path in a transport direction and a control device controls the movements of the transport movers in the path system; and
a transfer device transfers portions from the conveying apparatus to at least one packaging apparatus,
wherein the transfer device forms a single-line or multi-line format set from a plurality of portions of different transport movers and transfers the format set as a whole to the packaging apparatus by means of which the portions are packaged.
